(19) United States
(12) Patent Application Publication
(10) Pub. No.: US 2026/0361107 A1
(43) Pub. Date: Nov. 12, 2026

(54) MULTI-BAY BATTERY PACK CHARGER WITH CURRENT SHARING FOR OPTIMIZED CHARGING

(71) Applicant: MILWAUKEE ELECTRIC TOOL CORPORATION, Brookfield, WI (US)

(72) Inventors: James K. Dykstra, Milwaukee, WI (US); Tyler J. Thenell, Milwaukee, WI (US); Vivek S. Nagal, Sussex, WI (US); Xuechao Wang, Pewaukee, WI (US); Paul C. Chao, Menomonee Falls, WI (US)

(21) Appl. No.: 19/673,502

(22) Filed: May 11, 2026

Related U.S. Application Data
(60) Provisional application No. 63/853,122, filed on Jul. 29, 2025.
(60) Provisional application No. 63/804,182, filed on May 12, 2025.

(51) Int. Cl. H02J 7/70; H02J 7/34; H02J 7/44; H02J 7/90

(52) U.S. Cl. CPC H02J 7/751; H02J 7/34; H02J 7/44; H02J 7/933; H02J 2207/20

(57) ABSTRACT

A method for operating a battery pack charger includes assigning a first buck converter to a first charging bay, assigning a second buck converter to a second charging bay, assigning an initial charging current to the first charging bay and the second charging bay, assigning an additional charging current to the first charging bay after the initial charging current is assigned to the first charging bay and the second charging bay, providing the additional charging current via the first buck converter to the first charging bay, and providing the initial charging current via the second buck converter to the second charging bay.

### RELATED APPLICATIONS

This application claims the benefit of U.S. Provisional Patent Application No. 63/804,182, filed May 12, 2025, and U.S. Provisional Patent Application No. 63/853,122, filed Jul. 29, 2025, the entire content of each of which is incorporated herein by reference.

### FIELD

Embodiments described herein relate to battery pack chargers.

### SUMMARY

As battery pack-powered devices increasingly rely on multi-bay chargers to service multiple battery packs concurrently, chargers must operate under finite electrical constraints while accommodating changing charging demands. In conventional systems, charging behavior is fixed or only loosely coordinated across charging bays, such that available charging capacity may not be effectively distributed when multiple battery packs are present. This can result in inefficient utilization of available charging power, extended charge times, and an inability to adapt charging behavior as battery packs are connected, removed, or change charging condition during operation. These limitations are exacerbated in chargers designed to support multiple charging bays, where differences in connection timing, charge requirements, and system-level power constraints can create competing charging demands.

The embodiments described herein address these challenges by providing a battery pack charging architecture and associated control techniques that dynamically manage charging behavior across a plurality of charging bays. In various embodiments, the charger coordinates the assignment of charging resources to charging bays in view of system-level charging constraints, rather than treating each bay in isolation. Charging current may be distributed among charging bays in multiple stages, such as by initially provisioning baseline charging current and then selectively directing additional charging current based on operational conditions. By accounting for overall charging capacity and coordinating delivery of charging current across multiple bays, the charger can improve utilization of available charging resources, reduce total charging time, and provide flexible, adaptive charging behavior suitable for a wide range of multi-bay charging scenarios.

Embodiments described herein provide control techniques for a multi-bay battery pack charger to increase charging rates of battery packs to reduce the amount of time required to charge the battery packs.

Methods described herein for operating a battery pack charger include assigning a first buck converter to a first charging bay, assigning a second buck converter to a second charging bay, assigning a first initial charging current to the first charging bay and a second initial charging current the second charging bay, assigning an additional charging current to the first charging bay after the first initial charging current is assigned to the first charging bay and the second initial charging current is assigned to the second charging bay, providing the additional charging current via the first buck converter to the first charging bay, and providing the second initial charging current via the second buck converter to the second charging bay.

In some aspects, the method further includes determining a third charging current.

In some aspects, the method further includes assigning the third charging current to the second charging bay after the additional charging current is assigned to the first charging bay.

In some aspects, the additional charging current and the third charging current are at least one selected from a group consisting of: a maximum charging current, a requested charging current, and a remaining charging current.

In some aspects, the additional charging current and the remaining charging current are equal.

In some aspects, the remaining charging current is equal to zero.

In some aspects, the first initial charging current is a current limit of the first buck converter.

In some aspects, the first initial charging current is a current limit of the first buck converter added to a maximum sharing current.

Battery pack chargers described herein include a plurality of charging bays, each charging bay configured to couple to a battery pack, a plurality of buck converters, and a controller coupled to the plurality of charging bays and the plurality of buck converters. The controller is configured to assign a buck converter to each charging bay of the plurality of charging bays that is coupled to a battery pack that requires a charging current, assign a first initial charging current to a first charging bay and a second initial charging current to a charging bay of the plurality of charging bays, after assigning the first initial charging current to the first charging bay and the second initial charging current to the second charging bay, assign an additional charging current to the first charging bay, provide the additional charging current via a first buck converter of the plurality of buck converters to the first charging bay, and provide the second initial charging current via a second buck converter of the plurality of buck converters to the second charging bay.

In some aspects, the controller is configured to assign at least one buck converter to each charging bay that is connected to a battery pack that requires a charging current.

In some aspects, the controller is configured to assign buck converters to the plurality of charging bays based on an order in which battery packs are connected to the plurality of charging bays.

In some aspects, after assigning an additional charging current to a first charging bay, the controller is configured to assign additional charging current to one or more remaining charging bays.

In some aspects, the additional charging current is at least one selected from a group consisting of a maximum charging current, a requested charging current, and a remaining charging current.

In some aspects, the controller is configured to determine an available charging current of the battery pack charger and assign additional charging current to one or more charging bays until the available charging current has been assigned.

In some aspects, the controller is configured to assign charging currents to the plurality of buck converters, and the plurality of buck converters is configured to provide the assigned charging currents to the plurality of charging bays.

In some aspects, the controller is configured to determine a requested charging current for a charging bay and assign the requested charging current to the charging bay.

Battery pack charger systems described herein include a plurality of charging bays, a plurality of battery packs coupled to the plurality of charging bays, a plurality of buck converters configured to provide charging currents to the plurality of charging bays, and a controller coupled to the plurality of charging bays and the plurality of buck converters. The controller is configured to assign a buck converter to each charging bay of the plurality of charging bays that is coupled to a battery pack that requires a charging current, assign an initial charging current to each charging bay of the plurality of charging bays that is coupled to a battery pack that requires a charging current, determine an available charging current of the battery pack charger system, and assign, after assigning the initial charging current to each charging bay of the plurality of charging bays that is coupled to a battery pack that requires a charging current, an additional charging current to one or more charging bays of the plurality of charging bays until the available charging current has been assigned. The plurality of buck converters provide the assigned charging currents to the plurality of charging bays.

In some aspects, the battery pack charger system assigns a maximum charging current to a first charging bay and assigns the maximum charging current to one or more remaining charging bays until an available charging current of the battery charger system has been assigned.

In some aspects, the battery pack charger system determines a requested charging current for a first charging bay and assigns the requested charging current to the first charging bay.

In some aspects, determining the requested charging current is based on at least one of a user input, a communication between a battery pack and the controller, or a detection of a parameter of the battery pack.

In some aspects, the controller is configured to determine a remaining charging current after assigning the initial charging current to each charging bay of the plurality of charging bays that is coupled to a battery pack that requires a charging current, assign at least some of the remaining charging current to a first charging bay, determine an updated remaining current, and assign the updated remaining current to one or more remaining charging bays.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather, these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1 %, 5 %, 10 %) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a multi-bay battery pack charger, according to embodiments described herein.

FIG. 2 illustrates a multi-bay battery pack charger, according to embodiments described herein.

FIGS. 3A-3B illustrate battery packs, according to embodiments described herein.

FIG. 4 illustrates a control system for the multi-bay battery pack charger of FIGS. 1 or 2, according to embodiments described herein.

FIG. 5A illustrates a schematic diagram for the multi-bay battery pack charger of FIGS. 1 or 2, according to embodiments described herein.

FIG. 5B illustrates a part of a schematic diagram for the multi-bay battery pack charger of FIGS. 1 or 2, according to embodiments described herein.

FIG. 5C illustrates a part of a schematic diagram for the multi-bay battery pack charger of FIGS. 1 or 2, according to embodiments described herein.

FIG. 6 is a process for providing a charging current to bays of the multi-bay battery pack charger of FIGS. 1 or 2, according to embodiments described herein.

FIG. 7 is a process for providing a charging current to bays of the multi-bay battery pack charger of FIGS. 1 or 2, according to embodiments described herein.

FIG. 8 is a process for providing a charging current to bays of the multi-bay battery pack charger of FIGS. 1 or 2, according to embodiments described herein.

FIG. 9 is a process for providing a charging current to bays of the multi-bay battery pack charger of FIGS. 1 or 2, according to embodiments described herein.

FIG. 10 is a process for providing a charging current to bays of the multi-bay battery pack charger of FIGS. 1 or 2, according to embodiments described herein.

FIG. 11 is a process for providing a charging current to bays of the multi-bay battery pack charger of FIGS. 1 or 2, according to embodiments described herein.

FIGS. 12-16 illustrate a process for providing a charging current to bays of the multi-bay battery pack charger of FIGS. 1 or 2, according to embodiments described herein.

FIGS. 17-18 illustrate a process for providing a charging current to bays of the multi-bay battery pack charger of FIGS. 1 or 2, according to embodiments described herein.

### DETAILED DESCRIPTION

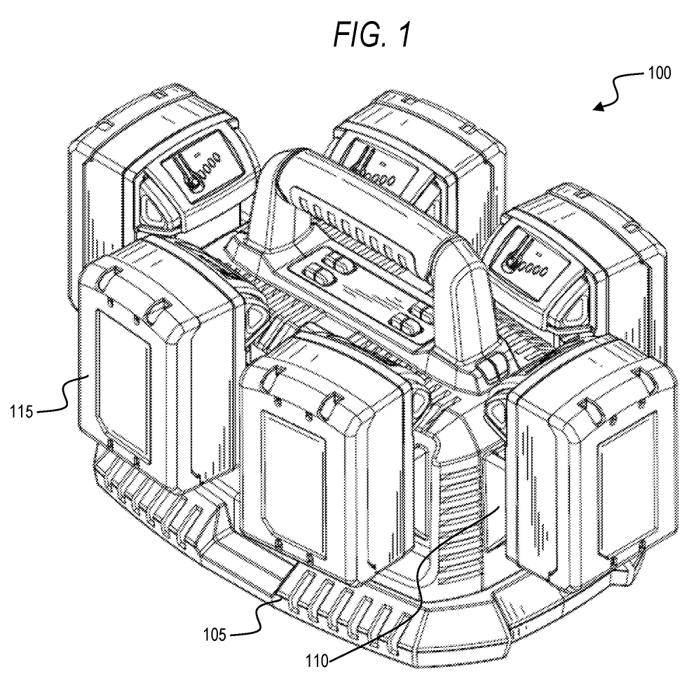

FIG. 1 illustrates a multi-bay battery pack charger 100. The multi-bay battery pack charger (“charger”) 100 includes a housing 105 and battery receptacles 110 for receiving battery packs 115. The charger 100 is configured to distribute power to the battery packs 115. The battery packs 115 are configured to provide power to peripheral devices. The peripheral devices may be a handheld power tool or the like. The charger 100 is also configured to receive power from a power source and use the power from the power source to distribute charging power to the battery packs 115. In some embodiments, the power source is a DC power source, for example, a photovoltaic cell (e.g., a solar panel) or one or more batteries. In other embodiments, the power source is an AC power source, for example, a conventional wall outlet.

The battery receptacles 110 are positioned on the exterior of the housing 105 and are configured to receive the battery packs 115. In the illustrated embodiment, the battery packs 115 are slide-on style battery packs. Accordingly, the battery receptacles 110 include guide rails to receive the slide-on style battery packs and latching mechanisms to secure the two components together. In the illustrated embodiment, the battery packs 115 are 18 Volt battery packs having a lithium-based chemistry. However, the battery packs 115 may also be 6 Volt battery packs, 12 Volt battery packs, 24 Volt battery packs, 40 Volt battery packs, 80 Volt battery packs, or another value between 6 Volts and 120V, and having a lithium-based chemistry.

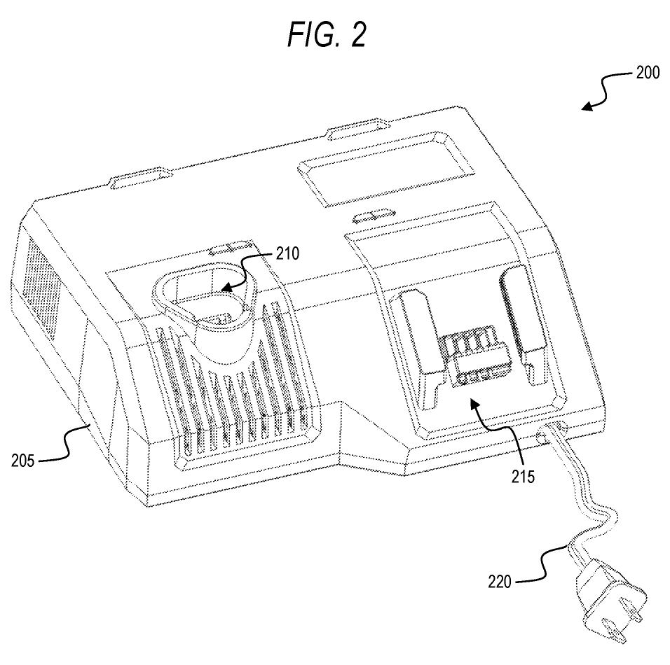

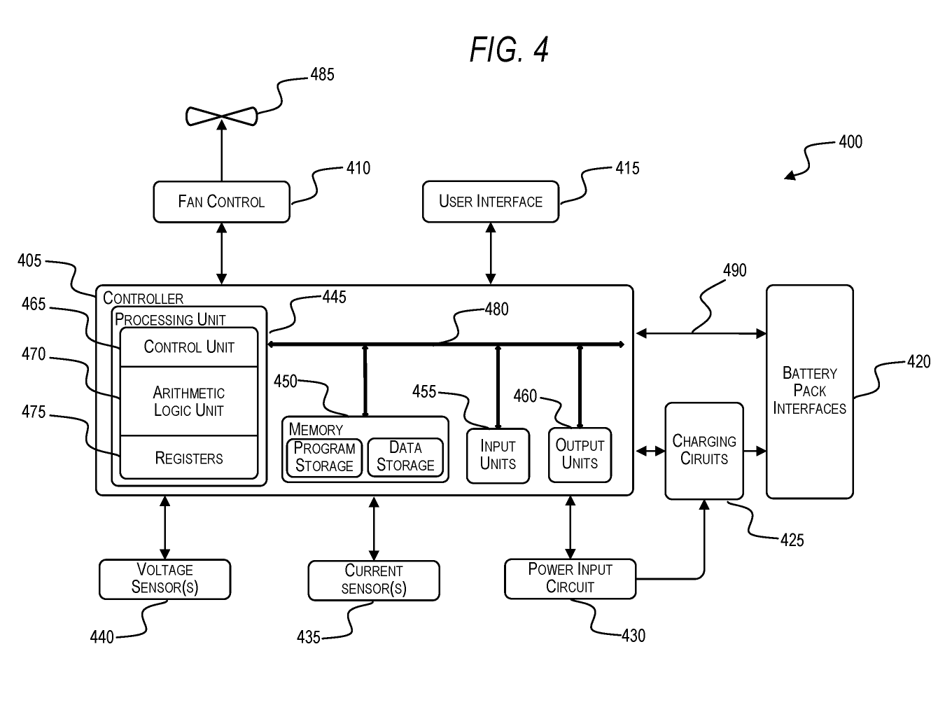

FIG. 2 illustrates a battery pack charger 200. The battery pack charger 200 includes a housing 205, interface portions 210, 215, and a cord 220. The interface portions 210, 215 electrically connect the battery pack charger 200 to one or more battery packs (e.g., battery pack 115) through charging circuits. For example, a charging circuit provides power to a battery pack from a power input circuit that is powered by a power source (see FIG. 4). The cord 220 allows the battery pack charger 200 to receive power from an external power source (e.g., a conventional wall outlet).

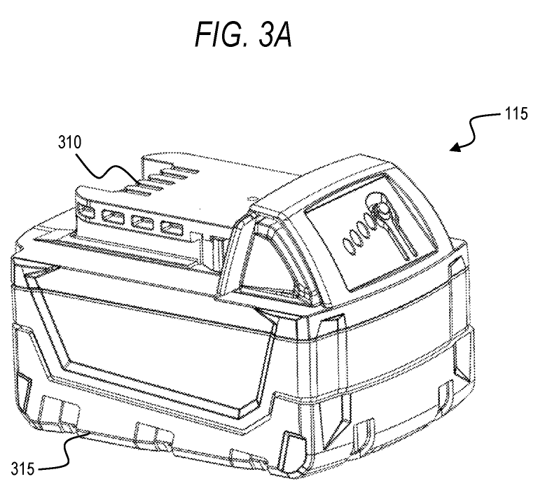

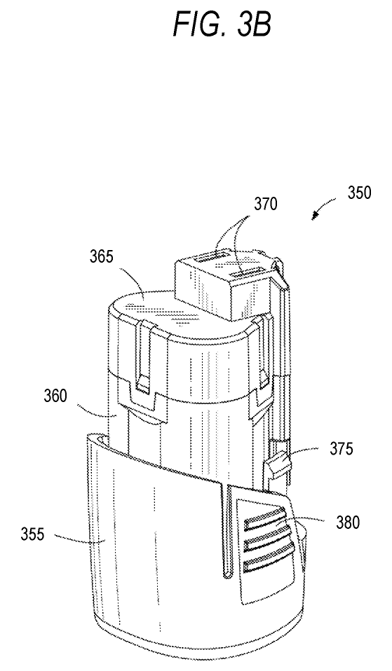

FIG. 3A illustrates the battery pack 115 that is configured to receive power from the charger 100, 200. The battery pack 115 of FIG. 3A includes a housing 315 and an interface portion 310 for connecting the battery pack 115 to a device (e.g., a power tool) or a battery pack charger (e.g., charger 100, 200). FIG. 3B illustrates a battery pack 350. The battery pack 350 includes a battery pack housing 355 which couples with a power tool or a battery pack charger (e.g., charger 200). The battery pack 350 further includes a lower portion 360 of a battery cell housing and an upper portion 365 of the battery cell housing. The battery pack 350 includes terminals 370. The terminals 370 are electrically connected to the battery cells. The terminals 370 are configured to couple with the battery pack charger 200 when the battery pack 350 is coupled to the interface portion 210. The battery pack housing 355 includes a locking mechanism 375 which includes a button 380 on the outside of the battery pack housing 355. When the battery pack 350 is connected to the interface portion 210, the locking mechanism 375 can couple to the interface portion 210. The locking mechanism 375 prevents disconnection of the battery pack 350 when coupled to the interface portion. When the button 380 is pressed, the locking mechanism 375 can be disconnected from the interface portion 210, allowing the battery pack 350 to be removed.

FIG. 4 illustrates a control system 400 for the charger 100, 200. The control system 400 includes a controller 405. The controller 405 is electrically and/or communicatively connected to a variety of modules or components of the charger 100, 200. For example, the illustrated controller 405 is electrically connected to a fan control 410, a user interface 415, battery pack interfaces 420, charging circuits 425, a power input circuit 430, current sensors 435, and voltage sensors 440. The controller 405 includes combinations of hardware and software that are operable to, among other things, control the operation of the charger 100, 200. The fan control 410 operates a fan 485. In some embodiments, the user interface 415 includes a touchscreen. In some embodiments, the user interface 415 includes various components (e.g., switches, buttons, levers, dials, etc.) that allow a user to interface with and control the charger 100, 200.

The controller 405 includes a plurality of electrical and electronic components that provide power, operational control, and protection to the components and modules within the controller 405 and/or charger 100, 200. For example, the controller 405 includes, among other things, a processing unit 445 (e.g., a microprocessor, a microcontroller, an electronic controller, an electronic processor, or another suitable programmable device), a memory 450, input units 455, and output units 460. The processing unit 445 includes, among other things, a control unit 465, an ALU 470, and a plurality of registers 475 (shown as a group of registers in FIG. 4), and is implemented using a known computer architecture (e.g., a modified Harvard architecture, a von Neumann architecture, etc.). The processing unit 445, the memory 450, the input units 455, and the output units 460, as well as the various modules or circuits connected to the controller 405, are connected by one or more control and/or data buses (e.g., common bus 480). The control and/or data buses are shown generally in FIG. 4 for illustrative purposes. The use of one or more control and/or data buses for the interconnection between and communication among the various modules, circuits, and components would be known to a person skilled in the art in view of the embodiments described herein.

The memory 450 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 445 is connected to the memory 450 and executes software instructions that are capable of being stored in a RAM of the memory 450 (e.g., during execution), a ROM of the memory 450 (e.g., on a generally permanent basis), or another non-transitory computer readable medium such as another memory or a disc. Software included in the implementation of the charger 100, 200 can be stored in the memory 450 of the controller 405. The software includes, for example, firmware, one or more applications, program data, filters, rules, one or more program modules, and other executable instructions. The controller 405 is configured to retrieve from the memory 450 and execute, among other things, instructions related to the control processes and methods described herein. In other constructions, the controller 405 includes additional, fewer, or different components.

The battery pack interfaces 420 include a combination of mechanical components (e.g., rails, grooves, latches, etc.) and electrical components (e.g., one or more terminals) configured to and operable for interfacing (e.g., mechanically, electrically, and communicatively connecting) the charger 100, 200 with a battery pack (e.g., battery pack 115, battery pack 350, etc.). For example, the battery pack interfaces 420 are configured to receive power through the charging circuits 425 via the power input circuit 430. The battery pack interfaces 420 are also configured to communicatively connect to the controller 405 via one or more communications lines 490.

The controller 405 is configured to control the transfer of power to the charging circuits 425 based on detected power conditions in the charger 100. For example, the current sensors 435 and the voltage sensors 440 communicate to the controller 405 the amount of current and voltage available in the charger 100, respectively. The individual charging circuits 425 communicate to the controller 405 the amount of power needed or requested by the battery packs 115, 350 that are electrically connected to the respective charging circuits 425. The controller 405 is configured to detect an overpower condition (e.g., when the battery packs 115, 350 collectively require more power than is available to the charger 100). If the controller 405 detects an overpower condition while multiple battery packs 115, 350 are being charged by the charger 100, 200, the controller 405 can reduce the amount of charge power available to at least one of the battery packs 115, 350 (e.g., reduced to a non-zero power value).

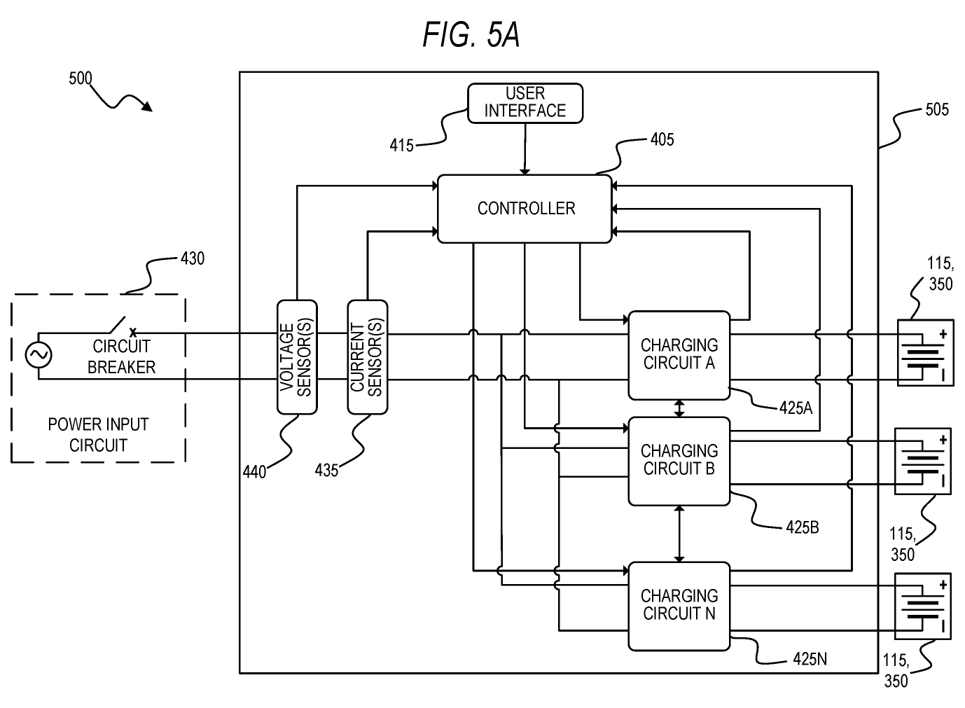

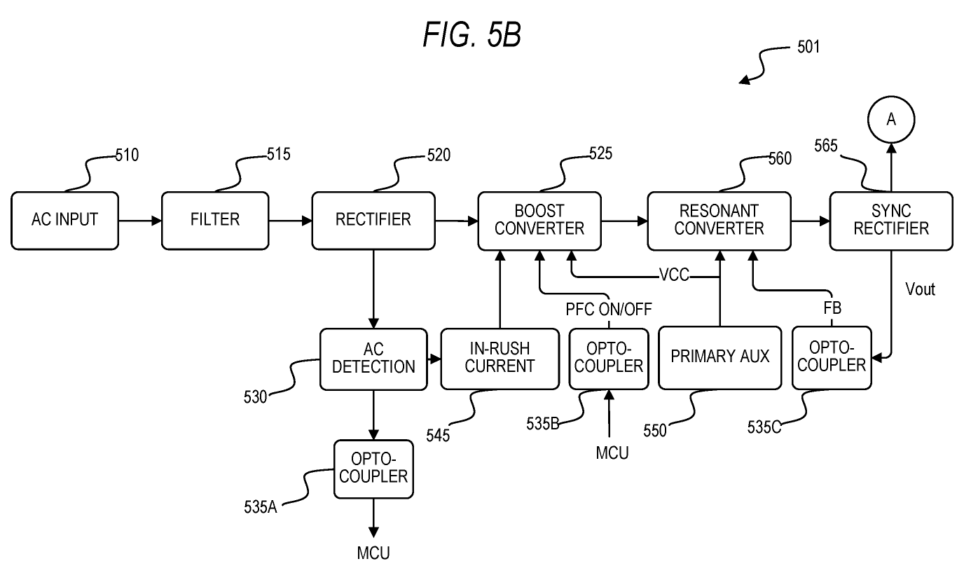

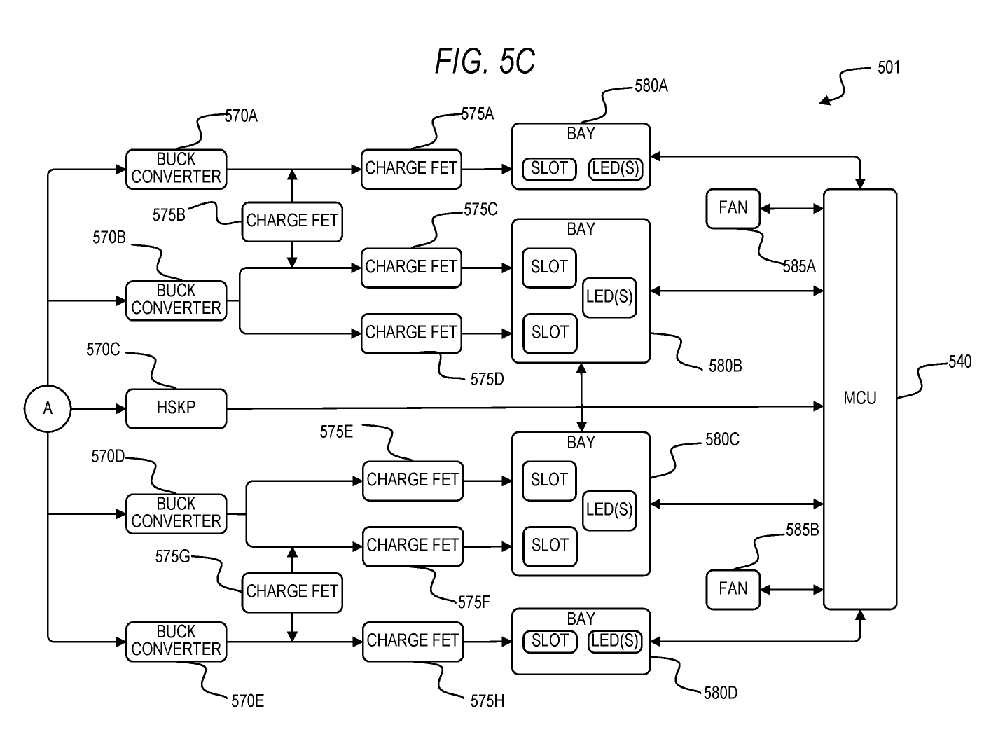

FIG. 5A illustrates a schematic diagram 500 of the charger 100 of FIG. 1 or charger 200 of FIG. 2. The schematic diagram 500 includes the power input circuit 430, a charging system 505, and a plurality of battery packs 115. The charging system 505 includes the controller 405, the user interface 415, individual charging circuits 425A-425N (N indicating an indeterminate number of potential charging circuits), the current sensors 435, and the voltage sensors 440. The power input circuit 430 provides power to the controller 405 and the charging circuits 425A-425N. The power input circuit 430 receives power from an external power source (e.g., a conventional wall outlet, one or more batteries, etc.) or an internal power source (e.g., one or more battery cells formed as a battery core). In some embodiments, the power input circuit 430 includes a circuit breaker for branch circuit protection. In other embodiments, the power input circuit 430 includes a fuse, an overload relay, etc.

The controller 405 receives inputs from, for example, the user interface 415, the individual charging circuits 425A-425N, the current sensors 435, and the voltage sensors 440. The user interface 415 receives inputs from a user and communicates the inputs to the controller 405. For example, the user interface 415 may allow the user to indicate input conditions (e.g., a branch circuit protection level, a selection of which battery packs to charge, a charging priority level, etc.). An amount of power needed or requested by each of the battery packs 115 or bays 110 is communicated to the controller 405 by the charging circuits 425 (e.g., based on information received from the battery packs 115 or information determined by the charging circuits 425). The current sensors 435 and voltage sensors 440 measure the current and voltage, respectively, from the power input circuit 430 and convert the measured values from the power input circuit 430 to usable signals (e.g., power available) received by the controller 405.

The controller 405 has outputs going to each individual charging circuit 425A-425N. The charging circuits 425A-425N include electronic circuits that take, for example, an input voltage and convert the input voltage to a usable charging voltage and current to charge the battery packs 115, 350. The controller 405 determines the amount of power that will flow to the battery packs 115, 350 based on the power available in the charger 100 and the power needed or requested by the battery packs 115, 350 or bays 110. The controller 405 communicates the determined amount of power (e.g., voltage and/or current) to the charging circuits 425A-425N to, for example, control a plurality of buck converters (e.g., step-down voltage converters) to provide a particular amount of charging power to each of the charging circuits 425A-425N. For example, each of the charging circuits 425A-425N includes one or more buck converters. In some embodiments, each charging circuit 425A-425N includes a primary buck converter and a secondary buck converter. In other embodiments, the charger 100, 200 includes a primary buck converter and a secondary buck converter. In such embodiments, the primary buck converter and the secondary buck converter can be located in one of the charging circuits 425-425N. The charging circuits 425A-425N are electrically connected to one another such that charging current can be distributed among the charging circuits 425A-425N from, for example, the primary buck converter and the secondary buck converter. The charging circuits 425A-425N are connected such that charging current from the primary buck converter and the secondary buck converter can be independently routed from the buck converters to any of the bays 110 and attached battery packs 115, 350 for charging. For descriptive purposes, the charging circuit 425A can be considered a primary buck converter and the charging circuits 425B-425N can be considered secondary buck converters. However, as described above, charging current from any of the buck converters can be routed using the charging circuits 425A-425N to any of the bays 110 to charge battery packs 115, 350. The charging circuits 425A-425N output the communicated amount of power (e.g., voltage and/or current) to the battery packs 115, 350. The controller 405 is able to sense if, or receive an indication that, a battery pack 115, 350 is removed from a charging circuit 425A-425N. The controller 405 can then terminate charging power to the affected charging circuit 425A-425N. For example, if the individual charging circuit 425A-425N is not electrically connected to a battery pack 115, then the controller 405 does not allow charging power to flow to the individual charging circuit 425A-425N, which allows for more power to be allocated to charging circuits 425A-425N that are electrically coupled to battery packs 115.

FIG. 5B illustrates a part of a schematic diagram 501 of another embodiment of the charger 100 of FIG. 1 or charger 200 of FIG. 2. This part of the schematic diagram 501 includes an alternating current (“AC”) input 510, a filter 515 (e.g., an electromagnetic interference filter), a rectifier 520, a boost converter 525 (e.g., a conduction mode interleaved power factor correction boost circuit), an AC detection unit 530, optocouplers 535A-C, a microcontroller unit (“MCU”) 540 (see FIG. 5C), an in-rush current control circuit 545, a primary auxiliary power supply 550, a resonant converter 560 (e.g., a half-bridge LLC resonant converter), and a synchronization rectifier 565. The AC input 510 supplies a voltage that ranges, for example, from 90-265 Volts AC supplied at a frequency of 50-60 Hz. The power from the AC input 510 passes through the above-mentioned components of this part of the schematic diagram 501 before reaching the buck converters 570A-E described below. The AC input 510 is input into the filter 515. The filter 515 is configured to filter out noise from the AC input 510, creating a cleaner AC signal. In some embodiments, the filter 515 is an electromagnetic interference (EMI) filter. Once filtered, the AC signal is output to various AC-powered components of the circuit illustrated in the schematic diagram 501, and the rectifier 520 receives the AC signal as an input. The rectifier 520 converts the AC signal into a DC signal. The DC signal is measured by the AC detection unit 530. Based on the measured DC signal, the AC detection unit 530 outputs an AC detection signal that is received by the MCU 540 through optocoupler 535A. The optocoupler 535A is operable to isolate the MCU 540 from the power electronics of the charger 100. The MCU 540 determines a state of the AC input 510 based on the AC detection signal. In some embodiments, the MCU 540 is configured to perform similar tasks as the controller 405. The MCU 540 sends a signal to the boost converter 525 through the optocoupler 535B based on the AC detection signal. In some embodiments, the boost converter 525 is controlled by a boost converter controller. In some embodiments, the boost converter controller is a power factor correction (PFC) controller configured to improve efficiency of power usage of the boost converter 525. In some embodiments, the signal from the MCU indicates PFC should be ON or OFF. In some embodiments, the MCU 540 is galvanically isolated from the rectifier 520 and the boost converter 525. The AC detection signal is also received by the in-rush current control circuit 545. The in-rush current control circuit 545 is configured to limit the high surge of current to the boost converter 525 that occurs when the AC input 510 first provides power to the charger 100 (e.g., the charger 100 is turned ON). The in-rush control circuit 545 determines when the AC input is first connected or turned on based on the AC detection signal. Additionally, the primary auxiliary power supply 550 is configured to provide an operational voltage (Vcc) to the boost converter 525 and the resonant converter 560.

The boost converter 525 is configured to step up the voltage of the DC signal provided by the rectifier 520. In some embodiments, the boost converter 525 is a CCM interleaved PFC boost converter. The boost converter 525 provides the DC signal with the stepped-up voltage to the resonant converter 560. The resonant converter 560 is configured to allow for zero-voltage switching (ZVS) or zero-current switching (ZCS) thereby minimizing switching losses and improving power conversion efficiency of the DC signal with the stepped-up voltage. In some embodiments, the resonant converter 560 is a DC-DC half-bridge LLC resonant converter. In some embodiments, the resonant converter 560 includes gallium nitride (GaN) switches. The resonant converter 560 is connected to the synchronization rectifier 565. In some embodiments, the synchronization rectifier 565 is galvanically isolated from the resonant converter 560. The synchronization rectifier 565 is configured to provide a feedback signal through the optocoupler 535C to the resonant converter 560 based on a DC signal output received from the resonant converter 560. The feedback signal is configured to synchronize the switching frequency of the resonant converter 560. In some embodiments, the switching frequency of the resonant converter 560 is synchronized with an external clock signal, which reduces noise and improves efficiency of the resonant converter 560. The synchronization rectifier 565 is connected to the buck converters 570A-E.

FIG. 5C illustrates another part of a schematic diagram 501 of the charger 100 of FIG. 1 or charger 200 of FIG. 2. This part of the schematic diagram 501 includes buck converters 570A-570E, charge switches (e.g., FETs) 575A-575H, charging bays 580A-580D, fans 585A-585B, and the MCU 540. In some embodiments, the buck converters 570A-570E are components of the charging circuits 425A-425N. In some embodiments, as illustrated in FIG. 5C, one of the converters (buck converter 570C) functions as a housekeeping power supply. In some embodiments, the charge switches 575A-575H are components of the charging circuits 425A-425N. In some embodiments, the bays 580A-580D are similar to bays 110, 210, 215. In some embodiments, this part of the schematic diagram 501 includes more or fewer buck converters, charge switches, bays, and fans. The charge switches 575A-575H are controlled by the MCU 540. In some embodiments, the charge switches 575A-575H are configured as switch pairs (e.g., FET switch pairs). The MCU 540 is configured to control the ON/OFF states of the charge switches 575A-575H. The MCU 540 is configured to control the states of the charge switches 575A-575H based on, for example, a charge priority of the bay connected to the charge switches 575A-575H, as described in greater detail below. The charge switches 575A-575H, with the exception of charge switch 575B and charge switch 575G, are each connected to a slot of a charging bay 580A-580D. Charge switch 575B and charge switch 575G are intermediary charge switches configured to connect at least two of the buck converters 570A-570E. Intermediary charge switches are advantageous as they allow at least two of the buck converters 570A-E to provide charging current to the bays 580A-580D, as described in greater detail below.

The slots of the bays 580A-580D are configured to receive a battery pack (e.g., battery pack 115, 350). The bays 580A-580D also include at least one LED or another visual indicator configured to indicate a charge status, a battery pack capacity, or a similar metric of the battery pack connected to the corresponding slot. In some embodiments, each slot includes one corresponding LED. In some embodiments, each slot includes a plurality of LEDs. In some embodiments, the charging bays 580A-580D include more or fewer slots to receive battery packs. The charging bays 580A-580D are connected to the MCU 540. The MCU 540 is configured to determine which of the charging bays 580A-580D include battery packs, and to determine an order in which the battery packs are inserted. The MCU 540 is configured to control the charge switches 575A-575H according to, for example, the order in which the battery packs are received by the charging bays 580A-580D. The MCU 540 can then assign a charging current to each of the charging bays 580A-580D by controlling the charge switches, which is described in greater detail below. The fans 585A-585B are configured to prevent the charging bays 580A-580D and associated circuitry from overheating when battery packs connected to the charging bays 580A-580D are being charged. The MCU 540 is configured to control the fans 585A-585B based on which of the charging bays 580A-580D are connected to battery packs. In the illustrated embodiment, there is one fan 585A-585B for every two charging bays 580A-580D. In some embodiments, there are greater than or fewer than two fans 585A-585B. In some embodiments, a maximum power output of the charger 100 is 800W or greater, and a maximum charging current of the charger 100 is 36 Amperes.

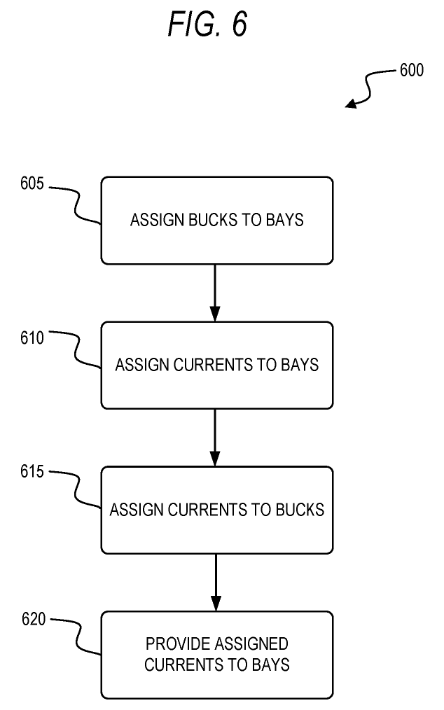

FIG. 6 is a process 600 for providing a charging current to bays 110, 210, 215 of the charger 100, 200. For every process step that the controller 405 is described as performing with respect to the following figures, it should be noted that the MCU 540 is configured to perform similar functions. Also, with respect to the bays 110, 210, and 215, it should be noted that bays 580A-D are configured to perform similar functions.

At block 605, the controller 405 assigns at least one buck converter to each of the bays 110, 210, 215 that are connected to a battery pack 115, 350 that requires a charging current. In some embodiments, the controller 405 receives a user input at the user interface 415 corresponding to which of the buck converters will be assigned to each of the bays 110, 210, 215. In some embodiments, the controller 405 assigns the buck converters to the bays 110, 210, 215 based on the order in which the battery packs 115, 350 were connected to the charger 100, 200. At block 610, the controller 405 assigns a charging current to each of the bays 110, 210, 215. In some embodiments, the charging currents are an initial or default charging current that is provided to each of the bays 110, 210, 215. In some embodiments, the initial charging current is equal to 6 Amps. However, in other embodiments, the initial charging current can have a different value (e.g., between 1 Amp and 15 Amps). At block 615, the controller 405 assigns the charging currents to the buck converters that will provide the charging currents to the bays 110, 210, 215. For example, if the charging current for a bay 110, 210, 215 is assigned to one of the buck converters, the one of the buck converters will provide the assigned charging current to the assigned bay 110, 210, 215. Additionally, if the charging current for a bay 110, 210, 215 is assigned to more than one of the buck converters, the controller 405 will determine that at least some of the assigned charging current will be provided to the bay 110, 210, 215 by a first buck converter of the buck converters and the controller 405 will determine that at least some of the assigned charging current will be provided to the bay 110, 210, 215 by a second buck converter of the buck converters (e.g., both the primary buck converter and the secondary buck converter provide charging current to the same bay 110, 210, 215). At block 620, the charger 100, 200 provides the assigned charging currents to the assigned bays 110, 210, 215 using the assigned buck converters.

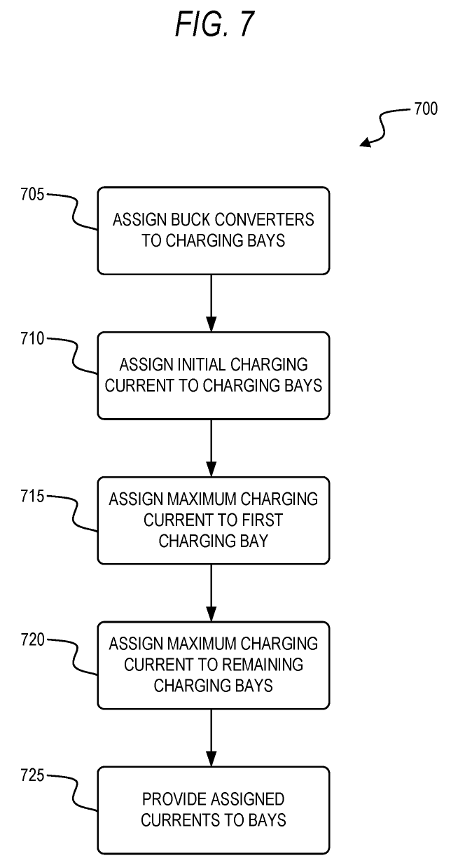

FIG. 7 is a process for providing a charging current to bays of the charger 100, 200, according to some embodiments. Block 705 is similar to block 605 described in greater detail above with respect to FIG. 6. The controller 405 assigns at least one buck converter to each of the bays 110, 210, 215 that are connected to a battery pack 115, 350 that requires a charging current (Block 705). At block 710, the controller 405 assigns an initial or default charging current to each of the bays 110, 210, 215. In some embodiments, the initial charging current is a current that is assigned to all the bays 110, 210, 215 that require charging current regardless of the user inputs at user interface 415 or the order in which the battery packs were connected to the respective bays 110, 210, 215. In some embodiments, the initial charging current is equal to 6 Amps. However, in other embodiments, the initial charging current can have a different value (e.g., between 1 Amp and 15 Amps).

At block 715, a maximum charging current is assigned to the bay 110, 210, 215 that has the battery pack that was connected to the charger 100, 200 first. For example, if the controller 405 determines that a battery pack 115 was connected to the bay associated with charging circuit 425A before another battery pack 115 was connected to a bay associated with one of charging circuits 425B-425N, then the bay associated with the charging circuit 425A will be assigned the maximum charging current. In some embodiments, the maximum charging current will be provided by a first buck converter, a second buck converter, or both (e.g., if the maximum charging current is greater than a current limit of the first buck converter). In some embodiments, the maximum charging current is the maximum charging current limit of at least one of the buck converters. In some embodiments, the maximum charging current limit of the at least one buck converter is 19 Amps. However, in other embodiments, the maximum charging current of the buck converters can have a different value (e.g., between 5 Amps and 40 Amps). In some embodiments, the maximum charging current limit of the at least one buck converter is 38 Amps. At block 720, the controller 405 determines that the maximum charging current can be assigned to one or more of the other bays 110, 210, 215. For example, the maximum charging current is assigned to the bays associated with the charging circuits 425B-425N. In some embodiments, the maximum charging current is assigned to each bay that requires a charging current until an available charging current of the charger 100, 200 has been assigned. For example, the bays associated with charging circuits 425A and 425B are both able to receive the maximum charging current. However, there is insufficient available current for the bay associated with charging circuit 425N to receive the maximum charging current. As a result, the process 700 tries to provide as much current to as many bays 110, 210, 215 as possible to increase charging speed. As described above, the priority for determining which bays receive increased charging current can be based on the order in which the battery packs 115, 350 are attached to the charger 100, 200. At block 725, the charger 100, 200 provides the assigned charging currents to the assigned bays 110, 210, 215 using the assigned buck converters.

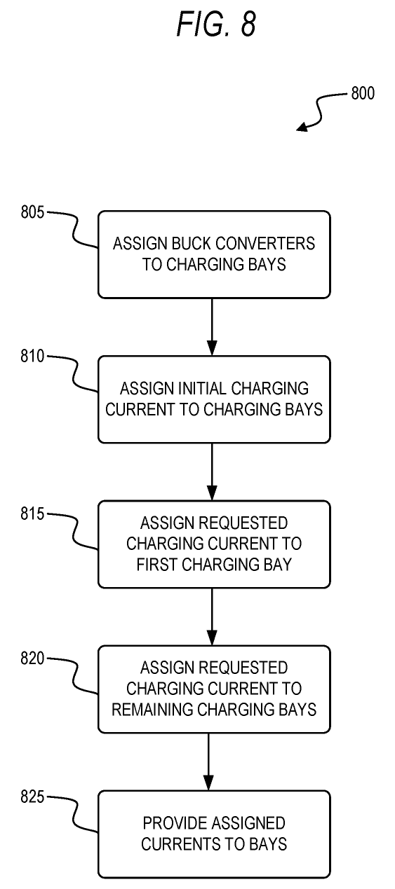

FIG. 8 is a process 800 for providing a charging current to bays of the charger 100, 200, according to some embodiments. Block 805 and block 810 are similar to block 705 and block 710 described in greater detail above with respect to FIG. 7. The controller 405 assigns at least one buck converter to each of the bays 110, 210, 215 that are connected to a battery pack 115, 350 that requires a charging current (Block 805). The controller 405 then assigns an initial or default charging current to each of the bays 110, 210, 215 (Block 810). At block 815, the controller 405 determines a requested charging current for the bay 110, 210, 215 that received a battery pack 115, 350 first. Determining the requested charging current can be based on, for example, a user input via the user interface 415, a communication between the battery pack 115, 350 and the charger 100, 200, a detection of a parameter of the battery pack 115, 350 by the charging circuit 425A-425N, etc. The controller 405 then assigns the requested current to the bay 110, 210, 215 that has the battery pack that was connected to the charger 100, 200 first. In this embodiment, for example, if the controller 405 determines that a battery pack 115 was connected to the bay associated with charging circuit 425A before another battery pack 115 was connected to a bay associated with one of charging circuits 425B-425N, then the bay associated with the charging circuit 425A will be assigned the requested charging current first and designated as the first charging bay. In some embodiments, the controller 405 determines that the bay 110, 210, 215 is a first charging bay based on a user input from the user interface 415. At block 820, the controller 405 determines a requested charging current for the remaining bays. Determining the requested charging current can be based on, for example, a user input via the user interface 415, a communication between the battery pack 115, 350 and the charger 100, 200, a detection of a parameter of the battery pack 115, 350 by the charging circuit 425A-425N, etc. In some embodiments, the remaining bays are assigned a requested charging current based on the order in which the battery packs 115, 350 were attached to the charger 100, 200. In some embodiments, the remaining bays are assigned a requested charging current based on an order selected through a user input via user interface 415. In some embodiments, the requested charging current is assigned to each remaining bay that requires a charging current until an available charging current of the charger 100, 200 has been assigned. For example, the bays associated with charging circuit 425A and 425B are both able to receive the requested charging current. However, there is insufficient available current for the bay associated with charging circuit 425N to receive the requested charging current. As a result, the process 800 tries to provide as much current to as many bays 110, 210, 215 as possible to increase charging speed. As described above, the priority for determining which bays receive increased charging current can be based on the order in which the battery packs 115, 350 are attached to the charger 100, 200 or a user input via user interface 415. At Block 825, the charger 100, 200 provides the assigned charging currents to the assigned bays 110, 210, 215 using the assigned buck converters.

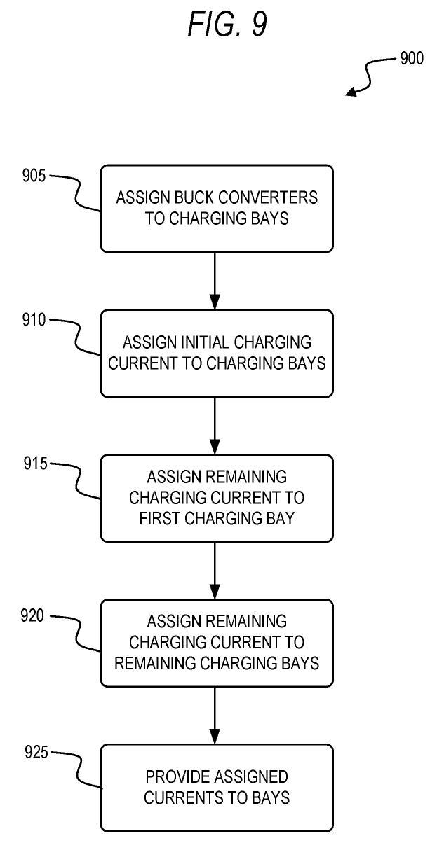

FIG. 9 is a process 900 for providing a charging current to bays of the charger 100, 200, according to some embodiments. Block 905 and block 910 are similar to block 705 and block 710 described in greater detail above with respect to FIG. 7. The controller 405 assigns at least one buck converter to each of the bays 110, 210, 215 that are connected to a battery pack 115, 350 that requires a charging current (Block 905). The controller 405 then assigns an initial or default charging current to each of the bays 110, 210, 215 (Block 910). At block 915, the controller 405 determines that at least some of a remaining charging current (after the initial charging currents are assigned) will be assigned to the bay 110, 210, 215 that received a battery pack 115, 350 first. For example, if the controller 405 determines that a battery pack 115 was connected to the bay associated with charging circuit 425A before another battery pack 115 was connected to a bay associated with one of charging circuits 425B-425N, then the bay associated with the charging circuit 425A will be assigned at least some of the remaining charging current first. In some embodiments, the amount of the remaining charging current that is assigned to the first bay is based on a maximum current capable of being received by the battery pack 115, 350, a maximum current of a buck converter, a predetermined amount above the initial charging current, etc. The remaining charging current is an available charging current as a portion of a total charging current limit of the charger 100, 200 that is not yet assigned to any of the bays 110, 210, 215. In some embodiments, all the remaining current is assigned to the bay 110, 210, 215 that received a battery pack 115, 350 first. In such an instance, each of the other bays that require a charging current will be assigned only the initial charging current. The controller 405 determines an updated remaining current. The updated remaining current is the current that remains after the initial current was assigned to the bay 110, 210, 215 that received a battery pack 115, 350 first and the at least some of the remaining charging current was also assigned to the bay 110, 210, 215 that received a battery pack 115, 350 first. The updated remaining current is then assigned to the remaining bays (Block 920). In some embodiments, the remaining charging current assigned to the remaining bays is equal to zero. In some embodiments, the remaining charging current is assigned to each bay that requires a charging current until the available charging current of the charger 100, 200 has been assigned. For example, the bays associated with charging circuit 425A and 425B are both able to receive some of the remaining charging current. However, there is insufficient available current for the bay associated with charging circuit 425N to receive any of the remaining charging current. As a result, the process 900 tries to provide as much current to as many bays 110, 210, 215 as possible to increase charging speed. As described above, the priority for determining which bays receive increased charging current can be based on the order in which the battery packs 115, 350 are attached to the charger 100, 200. At block 925, the charger 100, 200 provides the assigned charging currents to the assigned bays 110, 210, 215 using the assigned buck converters.

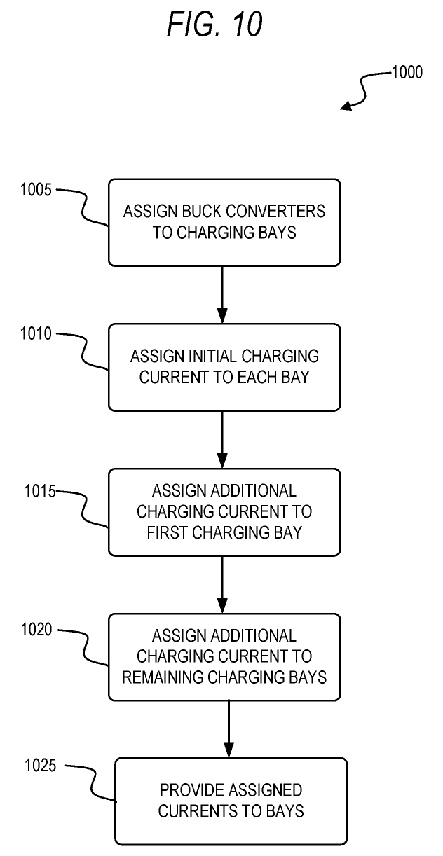

FIG. 10 is a process 1000 for providing a charging current to bays of the charger 100, 200, according to some embodiments. Block 1005 and block 1010 are similar to block 705 and block 710 described in greater detail above with respect to FIG. 7. The controller 405 assigns at least one buck converter to each of the bays 110, 210, 215 that are connected to a battery pack 115, 350 that requires a charging current (Block 1005). The controller 405 then assigns an initial or default charging current to each of the bays 110, 210, 215. At block 1015, the controller 405 determines an additional charging current and assigns the additional charging current to the bay 110, 210, 215 that received a battery pack 115, 350 first. In some embodiments, the amount of the additional charging current that is assigned to the first bay is based on a maximum current capable of being received by the battery pack 115, 350, a maximum current of a buck converter, a predetermined amount above the initial charging current, a percentage of the remaining charging current, etc. For example, if the controller 405 determines that a battery pack 115 was connected to the bay associated with charging circuit 425A before another battery pack 115 was connected to a bay associated with one of charging circuits 425B-425N, then the bay associated with the charging circuit 425A will be assigned the additional charging current first. At block 1020, additional charging current is then assigned to the remaining bays until there is no additional charging current to be assigned. As a result, the process 1000 tries to provide as much current to as many bays 110, 210, 215 as possible to increase charging speed. As described above, the priority for determining which bays receive increased charging current can be based on the order in which the battery packs 115, 350 are attached to the charger 100, 200. At block 1025, the charger 100, 200 provides the assigned charging currents to the assigned bays 110, 210, 215 using the assigned buck converters.

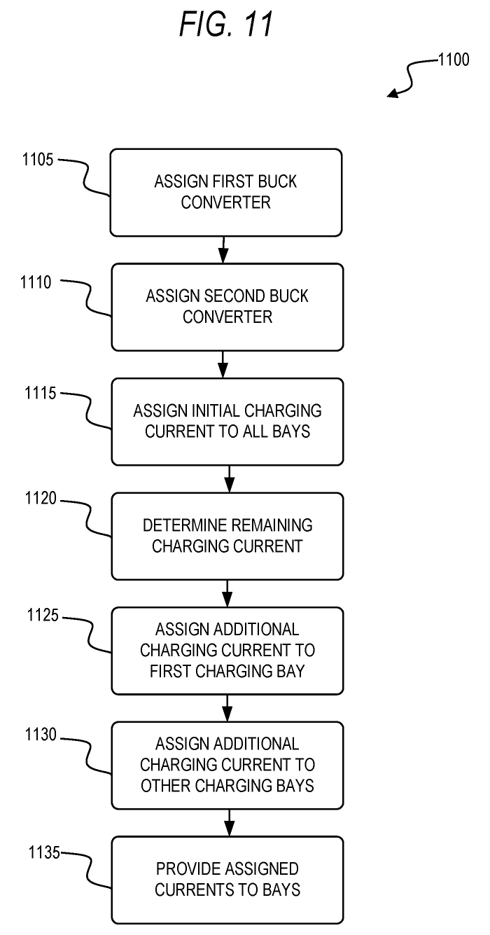

FIG. 11 is a process 1100 for providing a charging current to bays of the charger 100, 200, according to some embodiments. At block 1105, the controller 405 assigns a first buck converter (e.g., a primary buck converter) to at least one of the bays 110, 210, 215 connected to a battery pack 115, 350 that requires a charging current. In some embodiments, the controller 405 assigns the first buck converter to the bay associated with the charging circuit 425A-425N with the battery pack 115, 350 that was connected to the charger 100, 200 first. After the first buck converter is assigned, the controller 405 assigns the second buck converter to at least one of the bays 110, 210, 215 at block 1110. In some embodiments, the order in which the first buck converter and the second buck converter are assigned to the bays 110, 210, 215 depends on the order that the battery packs 115, 350 were attached to the bays 110, 210, and 215 of the charger 100, 200. At block 1115, the controller 405 assigns an initial charging current to each of the bays 110, 210, 215 that requires a charging current. At block 1120, the controller 405 determines a remaining charging current that remains of a total available charging current of the charger 100, 200 after the initial charging current is assigned to each of the bays 110, 210, 215 that requires a charging current. At block 1125, the controller 405 determines an additional charging current and assigns the additional charging current to the bay 110, 210, 215 that received a battery pack 115, 350 first. In some embodiments, the amount of the additional charging current that is assigned to the first bay is based on a maximum current capable of being received by the battery pack 115, 350, a maximum current of a buck converter, a predetermined amount above the initial charging current, a percentage of the remaining charging current, etc. For example, if the controller 405 determines that a battery pack 115 was connected to the bay associated with charging circuit 425A before another battery pack 115 was connected to a bay associated with one of charging circuits 425B-425N, then the bay associated with the charging circuit 425A will be assigned the additional charging current first. At block 1130, additional charging current is then assigned to the remaining bays until there is no additional charging current to be assigned. As a result, the process 1100 tries to provide as much current to as many bays 110, 210, 215 as possible to increase charging speed. As described above, the priority for determining which bays receive increased charging current can be based on the order in which the battery packs 115, 350 are attached to the charger 100, 200. At block 1135, the charger 100, 200 provides the assigned charging currents to the assigned bays 110, 210, 215 using the assigned buck converters. The assigned charging currents are provided to the bays 110, 210, 215 using at least the first buck converter or the second buck converter.

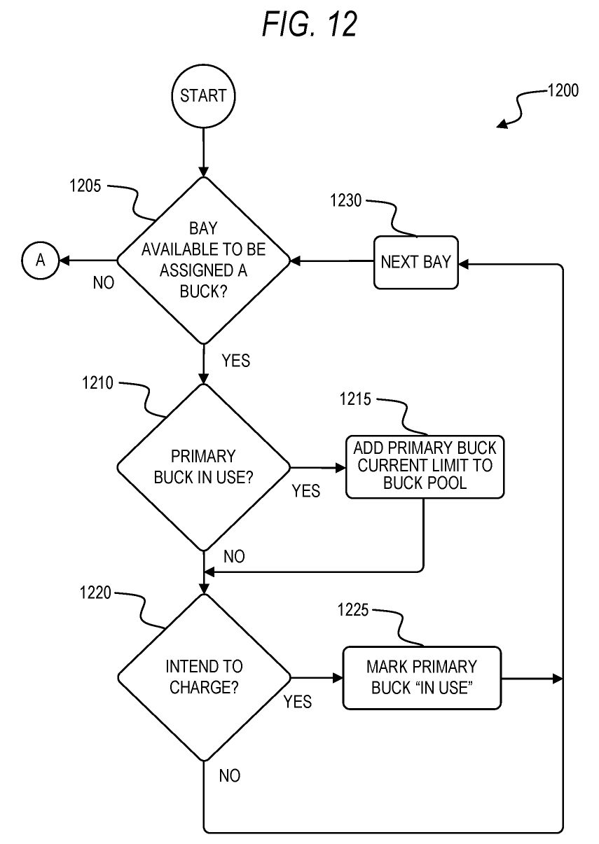

FIGS. 12-16 illustrate a process 1200 for assigning buck converters to bays 110, 210, 215, assigning charging currents to bays 110, 210, 215, and assigning charging currents to buck converters of the charger 100, 200, according to some embodiments. FIG. 12 illustrates a part of the process 1200 for assigning a primary buck converter. At block 1205, the controller 405 determines if one of the charging bays 110, 210, 215 is available to be assigned a buck converter (e.g., a primary buck converter, a secondary buck converter). In some embodiments, the controller first determines the availability of the bay 110, 210, 215 that received a battery pack 115, 350 first. In some embodiments, the controller 405 determines that the bay 110, 210, 215 is available if the bay 110, 210, 215 is connected to a battery pack 115, 350, the battery pack 115, 350 requires a charging current, and the bay 110, 210, 215 has not been assigned a buck converter. When the controller 405 determines that the bay 110, 210, 215 is available, the controller 405 determines if the primary buck converter is in use at block 1210. The primary buck converter is in use when the primary buck converter is assigned to the bay. If the controller 405 determines that the primary buck converter is in use, the process 1200 proceeds to block 1215. At block 1215, the primary buck current limit is added to a buck pool of the selected bay 110, 210, 215. In some embodiments, the primary buck current limit is the maximum current that the primary buck converter can output. The buck pool includes a total charging current assigned to the bay 110, 210, 215 to charge the battery pack 115, 350. If the controller 405 determines that the primary buck converter is not in use, then the process 1200 proceeds to block 1220. The process 1200 can also proceed to block 1220 if the primary buck converter is in use and the bay 110, 210, 215 is assigned the primary buck current limit. At block 1220, the controller 405 determines if the bay 110, 210, 215 intends to charge the battery pack 115, 350. In some embodiments, the bay 110, 210, 215 intends to charge the battery pack 115, 350 if the battery pack 115, 350 is attached to the bay 110, 210, 215 and requires a charging current. If the charging bay intends to charge, the primary buck converter is marked “in use” for the bay at block 1225 by the controller 405. At block 1230, the process 1200 moves to a next bay and the steps of the process 1200 illustrated in FIG. 12 are repeated for the next charging bay. In some embodiments, the order in which the bays 110, 210, 215 are evaluated with respect to the primary buck converter is based on the order that the bays 110, 210, 215 received a battery pack 115, 350. When all the bays 110, 210, 215 of the charger 100, 200 are evaluated by the controller 405 with respect to the primary buck converter, the process 1200 proceeds.

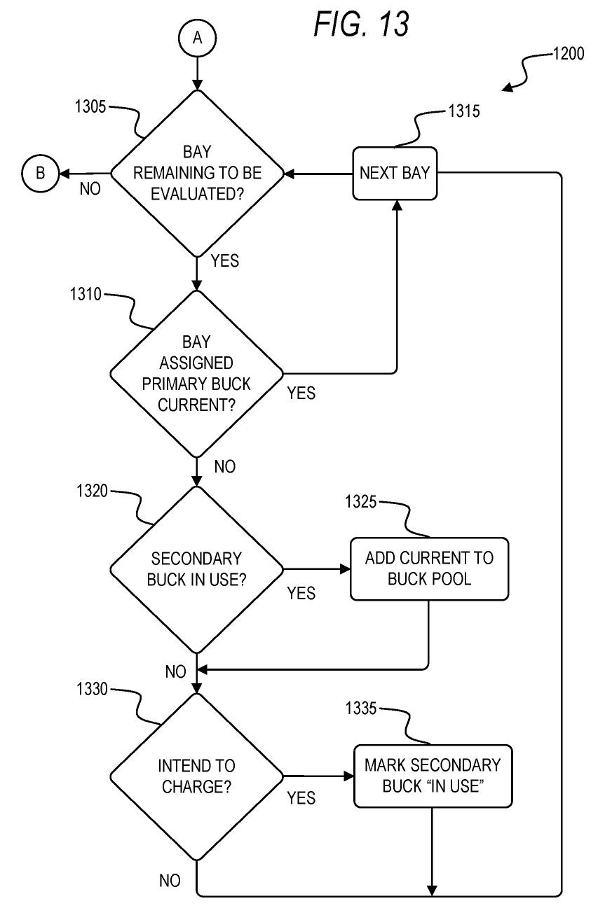

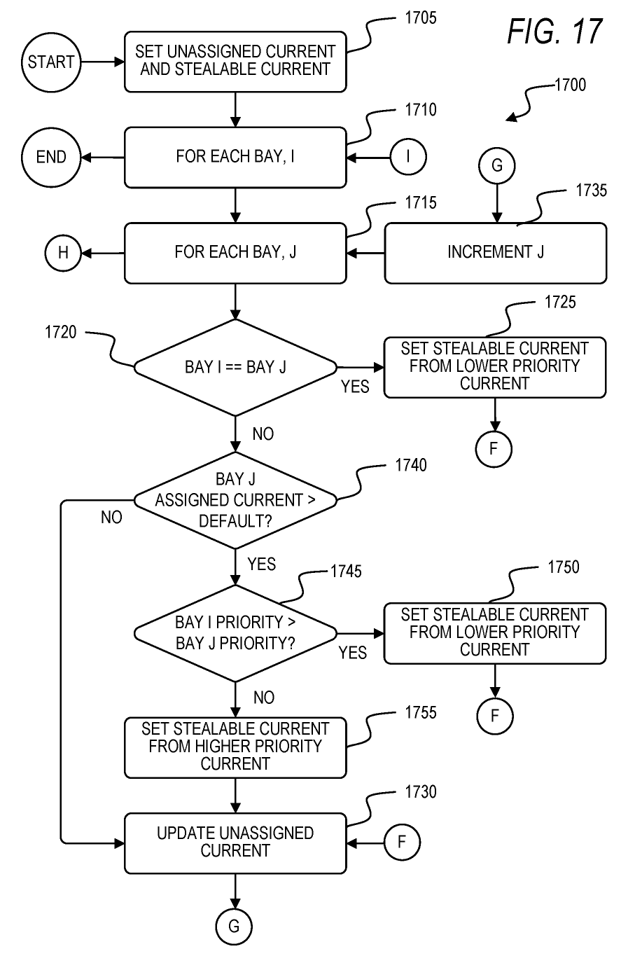

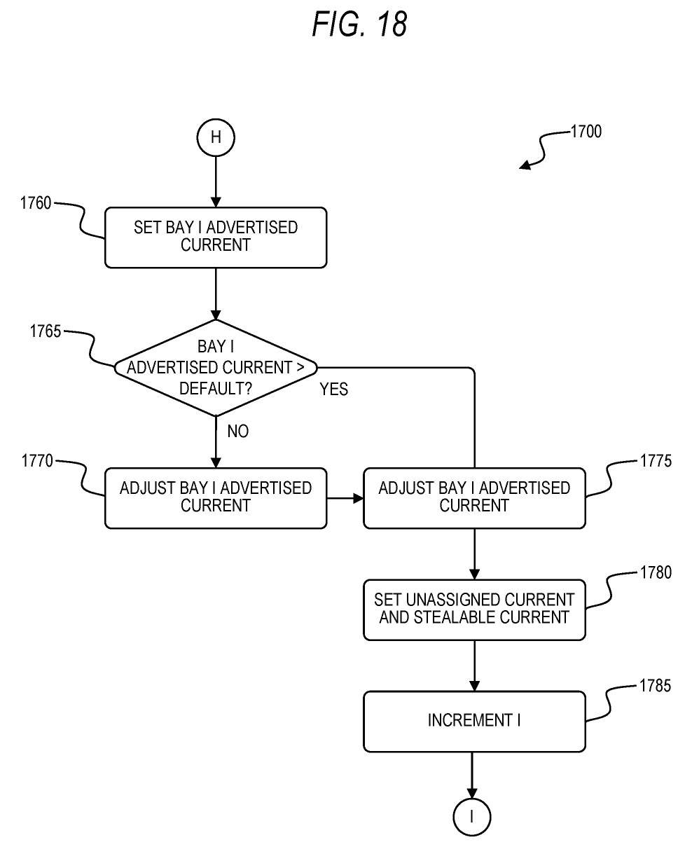

FIG. 13 illustrates a part of the process 1200 for assigning a secondary buck converter. At block 1305, the controller 405 determines if a bay 110, 210, 215 is remaining to be evaluated. The bay 110, 210, 215 is remaining to be evaluated if any of the bays 110, 210, 215 has not yet been evaluated using the process blocks of FIG. 13. In the case that the charging bay is remaining to be evaluated, the process 1200 proceeds to block 1310. At block 1310, the controller 405 determines if the bay 110, 210, 215 was assigned the primary buck current limit at block 1215 of FIG. 12. When the bay 110, 210, 215 was assigned the primary buck current limit at block 1215, the controller 405 proceeds to evaluate the next bay at block 1315. When the bay 110, 210, 215 is not assigned the primary buck current limit, the controller 405 determines whether the secondary buck converter is in use at block 1320. The secondary buck converter is in use when the selected bay is assigned the secondary buck converter. If the secondary buck converter is in use, the controller 405 assigns the secondary buck current to the buck pool of the selected bay 110, 210, 215 at block 1325. In some embodiments, the secondary current assigned to the buck pool of the selected bay 110, 210, 215 is the minimum value of the secondary buck current limit and a maximum stealable current. The maximum stealable current is described in greater detail with respect to FIGS. 17-18. If the controller 405 determines that the secondary buck converter is not in use, the controller determines if the bay 110, 210, 215 intends to charge a battery pack 115, 350. In some embodiments, the bay 110, 210, 215 intends to charge the battery pack 115, 350 if the battery pack 115, 350 is attached to the bay 110, 210, 215 and requires a charging current. If the bay 110, 210, 215 intends to charge, the secondary buck is marked “in use” at block 1335 by the controller. When the controller determines that the bay 110, 210, 215 does not intend to charge at block 1330 or the secondary buck is marked as “in use” at block 1335, the parts of the process 1200 illustrated in FIG. 13 repeat for the next bay at block 1315. In some embodiments, the order in which the bays 110, 210, 215 are evaluated with respect to the secondary buck converter is based on the order that the bays 110, 210, 215 received a battery pack 115, 350. When all the bays 110, 210, 215 of the charger 100, 200 are evaluated by the controller 405 with respect to the secondary buck converter, the process 1200 proceeds.

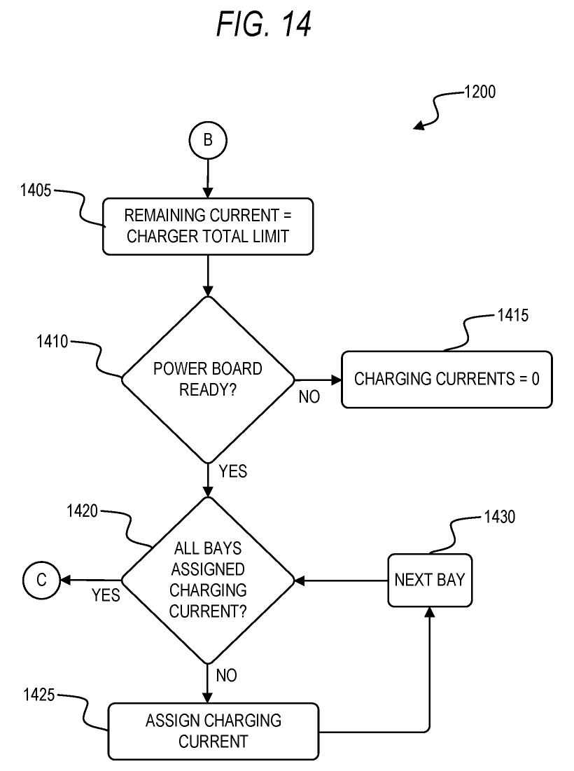

FIG. 14 illustrates a part of the process 1200 for assigning charging currents to the bays 110, 210, 215. At block 1405, the controller 405 sets a remaining current equal to the total current limit of the charger 100, 200. The remaining current is the charging current still left to be assigned by the controller 405 to the bays 110, 210, 215 after the bays 110, 210, 215 are assigned the primary buck converter and the secondary buck converter. In some embodiments, the total current limit of the charger 100, 200 is 38 Amps. At block 1410, the controller 405 determines if a power board (e.g., power input circuit 430) is ready to provide power to the charging circuits 425A-425N (e.g., including the primary and secondary buck converters). The controller 405 determines that the power board is ready, for example, when the power board is receiving power from an external power source (e.g., a conventional wall outlet; one or more batteries, etc.) or an internal power source (e.g., one or more battery cells). If the controller 405 determines that the power board is not ready, the process 1200 proceeds to block 1415, and all the charging bay currents, primary buck current, and secondary buck current are assigned 0 Amps by the controller 405. If the controller 405 determines that the power board is ready to provide power to the charging circuits 425A-425N, the controller 405 evaluates whether the bays 110, 210, 215 are assigned charging currents at block 1420. In the case that at least one of the bays 110, 210, 215 is not assigned a charging current, the controller 405 assigns charging currents to each of the bays 110, 210, 215 without an assigned charging current at block 1425. In some embodiments, the controller 405 determines that a charging current will first be assigned to the bay 110, 210, 215 that received a battery pack 115, 350 first before the controller 405 assigns charging currents to the other bays. In some embodiments, the controller 405 assigns the bay 110, 210, 215 a charging current that is a minimum value selected from the following group: a default or initial charging current (e.g., 6 Amps), a requested charging current for the bay 110, 210, 215, a buck pool current limit of the bay 110, 210, 215, or the remaining current. Determining the requested charging current can be based on, for example, a user input via the user interface 415, a communication between the battery pack 115, 350 and the charger 100, 200, a detection of a parameter of the battery pack 115, 350 by the charging circuit 425A-425N, etc. The remaining charging current is an available charging current as a portion of a total charging current limit of the charger 100, 200 that is not yet assigned to any of the bays 110, 210, 215.

In some embodiments, if the controller 405 assigns a charging current to the bay 110, 210, 215 that is greater than a minimum current that the primary buck or the secondary buck can provide, the remaining current is updated to reflect the difference between the present remaining current and the charging current assigned to the bay 110, 210, 215. If the assigned charging current is less than or equal to the minimum current that the primary buck or the secondary buck can provide, the controller 405 assigns zero amps to the bay 110, 210, 215. At block 1430, the controller evaluates the next charging bay and repeats blocks 1420-1425 for the next charging bay. In some embodiments, the bays 110, 210, 215 are assigned charging currents in the order in which the battery packs 115, 350 were attached.

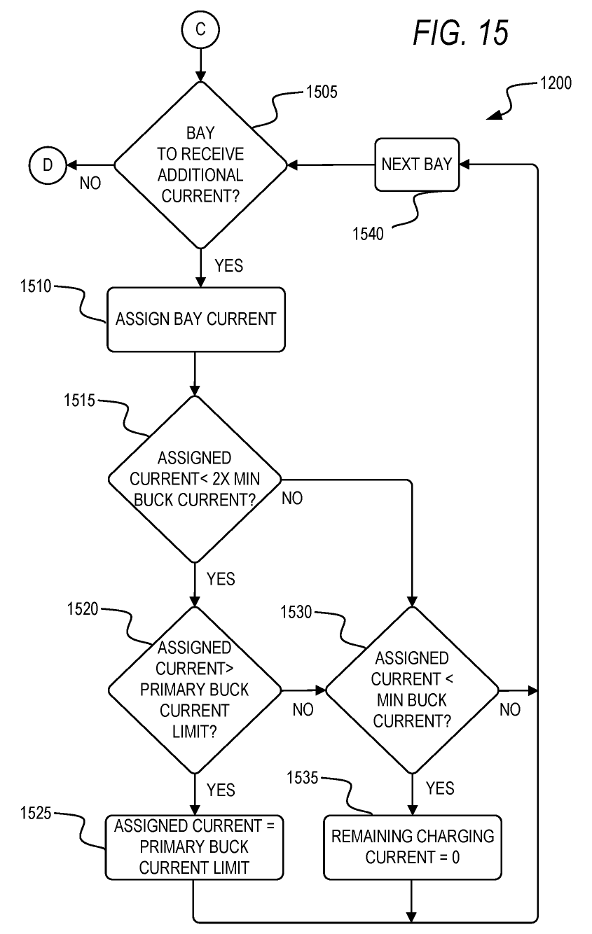

FIG. 15 illustrates a part of the process 1200 for assigning charging currents to the bays 110, 210, 215. At block 1505, the controller determines whether a bay 110, 210, 215 should receive additional charging current. The bay 110, 210, 215 can receive additional charging current after each bay 110, 210, 215 is assigned an initial charging current (see, e.g., block 1425 of FIG. 14). In some embodiments, the initial charging current is 6 Amps. At block 1510, the controller 405 assigns additional charging current to the bay 110, 210, 215. In some embodiments, the controller 405 determines that the additional charging current will first be assigned to the bay 110, 210, 215 that received a battery pack 115, 350 first before the controller 405 assigns the additional charging current to the other bays. The remaining current is updated by adding the present remaining current to the charging bay assigned current. The controller 405 then assigns the bay 110, 210, 215 a charging current that is a minimum value selected from the following group: the bay requested current, the bay buck pool limit, and the remaining current. Determining the requested charging current can be based on, for example, a user input via the user interface 415, a communication between the battery pack 115, 350 and the charger 100, 200, a detection of a parameter of the battery pack 115, 350 by the charging circuit 425A-425N, etc. In some embodiments, if the controller 405 assigns a charging current to the bay 110, 210, 215 that is greater than a minimum current that the primary buck or the secondary buck can provide, the remaining current is updated to reflect the difference between the present remaining current and the charging current assigned to the selected bay 110, 210, 215. If the assigned charging current is less than or equal to the minimum current that the primary buck or the secondary buck can provide, the controller 405 assigns zero amps to the bay 110, 210, 215. At block 1515, the controller 405 determines that the assigned current for the selected bay is less than double the minimum current that the primary buck converter or the secondary buck converter can provide. If the controller further determines that the charging current assigned to the bay 110, 210, 215 is greater than the primary buck current limit, then the current assigned to the bay 110, 210, 215 is set equal to the primary buck current limit (block 1525). In some embodiments, the primary buck current limit is 19 Amps. If either of the conditions presented in blocks 1515-1520 is not met, the controller determines whether the current assigned to the bay 110, 210, 215 is less than the minimum current that the primary buck converter and the secondary buck converter can provide (block 1530). If the condition presented in block 1530 is met, then the controller 405 assigns a charging current of zero amps to the selected bay 110, 210, 215 (block 1535). If the condition presented in block 1530 is not met or if the controller performs the assignments in block 1525 or block 1535, the process 1200 advances to block 1540 where the controller evaluates the next charging bay. The process is repeated until the controller 405 assigns additional charging currents to all the bays 110, 210, 215 that can receive additional charging current. In some embodiments, the additional charging current is zero amps. Once the bays 110, 210, 215 are all assigned a charging current, the process 1200 proceeds.

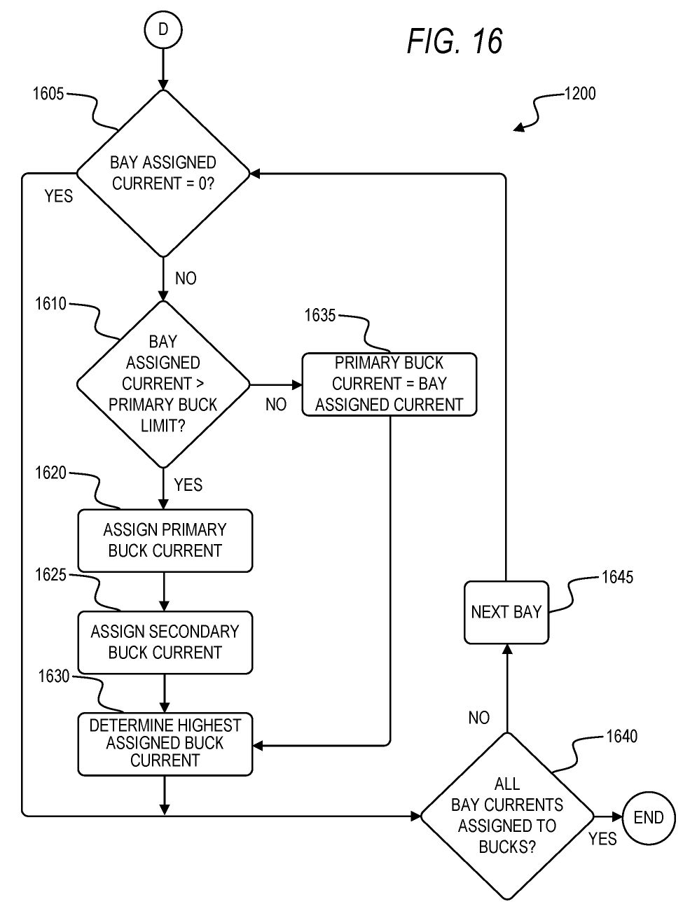

FIG. 16 illustrates a part of the process 1200 for assigning charging currents to the primary buck converter and the secondary buck converter. In some embodiments, the controller 405 first assigns the charging current of the bay 110, 210, 215 that received a battery pack 115, 350 first to the buck converters before the controller 405 assigns the charging current to the other bays to the buck converters. At block 1605, the controller 405 determines whether the charging current assigned to bay 110, 210, 215 is equal to zero amps. If the bay 110, 210, 215 has a non-zero assigned charging current, the controller 405 determines if the charging current assigned to bay 110, 210, 215 is greater than the primary buck current limit at block 1610. If the condition at block 1610 is met, the controller 405 assigns the primary buck converter at least a portion of the assigned charging current for the selected bay 110, 210, 215 at block 1620 and assigns the secondary buck converter at least a portion of the assigned current of the selected bay 110, 210, 215 at block 1625. The primary buck current is set equal to a minimum of the bay assigned current minus the minimum buck current and the primary buck limit. The secondary buck current is set to the bay assigned current minus the primary buck current. In this case, the number of bucks in use for the selected bay 110, 210, 215 is equal to 2. If the condition at block 1610 is not met, the controller 405 assigns the primary buck current to be the assigned charging current of the selected bay 110, 210, 215 at block 1635. In this case, the number of bucks in use for the selected bay 110, 210, 215 is equal to 1.

At block 1630, the controller 405 determines the highest current assigned to the selected bay 110, 210, 215. The controller 405 determines the highest current assigned to the selected bay 110, 210, 215 by setting the highest current assigned equal to the current assigned at either blocks 1620, 1625 or block 1635 and subtracts the number of bucks in use multiplied by a current derating value.

At block 1640, the controller 405 determines if there are any assigned charging currents for bays 110, 210, 215 that are not assigned to the primary buck converter or the secondary buck converter. If the controller 405 determines that no remaining charging currents assigned to bays 110, 210, 215 still need to be assigned to the buck converters, the controller terminates the process 1200. Otherwise, the process 1200 proceeds to the next bay 110, 210, 215 (block 1645). After all of the bucks and currents have been assigned, the controller 405 can control the charger 100, 200 to provide the charging currents to the bays 110, 210, 215.

FIG. 17-18 illustrate a process 1700 for advertising a charging current request change to the charging bays of the charger 100, 200, according to some embodiments. At block 1705, the controller 405 initially sets an unassigned current equal to the total current of the charger 100, 200. The unassigned current refers to a portion of the current limit of the charger 100, 200 that the controller did not assign to the bays 110, 210, 215 or the buck converters. The total current of the charger 100, 200 refers to the total charging current being provided to the bays 110, 210, 215. Additionally, the controller 405 initially sets the stealable current equal to zero at block 1705. The stealable current (or sharing current) refers to at least a portion of the assigned charging current of one bay that can be reappropriated by the controller 405 and used as the charging current of another bay. At block 1710 and block 1715, the controller 405 initializes a bay-to-bay comparison in which each bay 110, 210, 215 will be evaluated against every other bay in order to adjust the unassigned current, the stealable current, and the advertised current (see FIG. 18) of the bays 110, 210, 215. Each bay will be assigned as a bay i or a bay j. In some embodiments, the bays 110, 210, 215 are evaluated against one another based on the order that the bays 110, 210, 215 received a battery pack 115, 350. For example, if the bay 110, 210, 215 received a battery pack 115, 350 first, the bay 110, 210, 215 will be the first bay i to be compared to all the other bays.

At block 1720, the controller 405 determines whether bay i and bay j are equal (i.e., the same bay). In this case, the process 1700 proceeds to block 1725. At block 1725, a stealable current from a lower priority current is set. In some embodiments, the stealable current from a lower priority current refers to the assigned charging current of the bays that received battery packs after a certain bay. For example, if the bay 110, 210, 215 received a battery pack after at least one of the other bays, that bay 110, 210, 215 has a lower priority current. The stealable current from a lower priority current is equal to the assigned charging current of bay i added to the existing stealable current from a lower priority current. At block 1730, the unassigned current is updated. The updated unassigned current is equal to the difference between the present unassigned current and the assigned charging current of bay j. At block 1735, the value of j is incremented and a new bay j is compared to bay i. At block 1720, the controller 405 determines whether bay i is the same bay as bay j. If bay i and bay j are different bays, at block 1740, the controller determines whether the assigned charging current of bay j is greater than the initial or default current. In some embodiments, the default current is the initial charging current provided to the bays 110, 210, 215. In some embodiments, the default current is 6 Amps. If the controller 405 determines that the assigned current of bay j is not greater than the default current, the process 1700 proceeds to block 1730 as described in greater detail above. If the controller 405 determines that the assigned charging current of bay j is greater than the default charging current, then the process 1700 proceeds to block 1745. At block 1745, the controller determines whether the priority of bay i is greater than the priority of bay j. In some embodiments, the priority of the bays depends on the order in which the bays 110, 210, 215 received battery packs. If the controller 405 determines that the priority of bay i is greater than the priority of bay j, the process 1700 proceeds to block 1750. At block 1750, the controller 405 sets the stealable current from a lower priority current. In some embodiments, the stealable current from a lower priority current is equal to the present stealable current from a lower priority current added to the difference between the assigned current of bay j and the initial or default current. In some embodiments, the default current is 6 Amps.

If the controller 405 determines that the priority of bay i is not greater than the priority of bay j, a stealable current from a higher priority current is set. In some embodiments, the stealable current from the higher priority current is equal to the present stealable current from the higher priority current added to the difference between the bay j assigned current and the initial or default current. After the stealable currents are set at either block 1750 or 1755, the unassigned current is updated, as previously described with respect to block 1730. The process 1700 then proceeds to block 1735 where the value of j is incremented and the blocks 1715-1755 are repeated for the next bay j. However, if the value of j cannot be incremented any further (e.g., each bay j has been evaluated), the process 1700 proceeds to block 1760 of FIG. 18.

Referring now to FIG. 18, at block 1760, the advertised current of bay i is set. In some embodiments, the bay i advertised current is equal to the sum of the unassigned current and the stealable current from the lower priority current. At block 1765, the controller 405 determines if the bay i advertised current is greater than the initial or default current. If the controller 405 determines that the advertised current is not greater than the default current, the bay i advertised current is adjusted at block 1770. In some embodiments, the bay i advertised current is adjusted to equal the minimum of the following values: the sum of the present bay i advertised current and the stealable current from the higher priority current, and the buck pool current limit of bay i. If the controller 405 determines that the bay i advertised current is greater than the default current or the bay i advertised current is adjusted, the advertised bay i current is adjusted at block 1775. In some embodiments, the advertised current is equal to the minimum value of the bay i advertised current and the buck pool current limit of bay i. At block 1780, the controller 405 sets the unassigned current and the stealable current. In some embodiments, the unassigned current is set equal to the total current of the charger 100, 200. At block 1785, the value of i is incremented. In other words, a new bay i is compared to each bay j. However, if the value of i cannot be incremented any further (e.g., each bay i has been evaluated), the process 1700 proceeds to terminate. After the stealable currents have been set, the charging currents that are provided to the bays 110, 210, 215 can be updated or adjusted based on the stealable currents to provide additional charging current to one or more of the bays 110, 210, 215 (e.g., an updated requested charging current is provided and the process 1200 can be re-executed).

Thus, embodiments described herein provide, among other things, methods for charging battery packs connected to a multi-bay battery pack charger. Various features and advantages are set forth in the following claims.

What is claimed is:

1. A method for operating a battery pack charger, the method including:
assigning a first buck converter to a first charging bay;
assigning a second buck converter to a second charging bay;
assigning a first initial charging current to the first charging bay and a second initial charging current the second charging bay;
assigning an additional charging current to the first charging bay after the first initial charging current is assigned to the first charging bay and the second initial charging current is assigned to the second charging bay;
providing the additional charging current via the first buck converter to the first charging bay; and
providing the second initial charging current via the second buck converter to the second charging bay.

2. The method of claim 1, further comprising:
determining a third charging current.

3. The method of claim 2, further comprising:
assigning the third charging current to the second charging bay after the additional charging current is assigned to the first charging bay.

4. The method of claim 3, wherein the additional charging current and the third charging current are at least one selected from a group consisting of: a maximum charging current, a requested charging current, and a remaining charging current.

5. The method of claim 4, wherein the additional charging current and the remaining charging current are equal.

6. The method of claim 4, wherein the remaining charging current is equal to zero.

7. The method of claim 1, wherein the first initial charging current is a current limit of the first buck converter.

8. The method of claim 1, wherein the first initial charging current is a current limit of the first buck converter added to a maximum sharing current.

9. A battery pack charger comprising:
a plurality of charging bays, each charging bay configured to couple to a battery pack;
a plurality of buck converters; and
a controller coupled to the plurality of charging bays and the plurality of buck converters, the controller configured to:
assign a buck converter to each charging bay of the plurality of charging bays that is coupled to a battery pack that requires a charging current,
assign a first initial charging current to a first charging bay and a second initial charging current to a charging bay of the plurality of charging bays,
after assigning the first initial charging current to the first charging bay and the second initial charging current to the second charging bay, assign an additional charging current to the first charging bay,
provide the additional charging current via a first buck converter of the plurality of buck converters to the first charging bay, and
provide the second initial charging current via a second buck converter of the plurality of buck converters to the second charging bay.

10. The battery charger of claim 9, wherein the controller is configured to assign the buck converter to each charging bay based on an order in which battery packs are coupled to the plurality of charging bays.

11. The battery charger of claim 9, wherein the controller is configured to assign the additional charging current to one or more charging bays of the plurality of charging bays after assigning the additional charging current to the first charging bay.

12. The battery charger of claim 9, wherein the controller is configured to assign the additional charging current based on at least one selected from a group consisting of: a maximum charging current, a requested charging current, and a remaining charging current.

13. The battery charger of claim 12, wherein the additional charging current and the remaining charging current are equal.

14. The battery charger of claim 12, wherein the remaining charging current is equal to zero.

15. The battery charger of claim 9, wherein the controller is configured to assign charging currents to the plurality of buck converters, and wherein the plurality of buck converters is configured to provide the assigned charging currents to the plurality of charging bays.

16. A battery pack charger system comprising:
a plurality of charging bays;
a plurality of battery packs coupled to the plurality of charging bays;
a plurality of buck converters configured to provide charging currents to the plurality of charging bays; and
a controller coupled to the plurality of charging bays and the plurality of buck converters, the controller configured to:
assign a buck converter to each charging bay of the plurality of charging bays that is coupled to a battery pack that requires a charging current,
assign an initial charging current to each charging bay of the plurality of charging bays that is coupled to a battery pack that requires a charging current,
determine an available charging current of the battery pack charger system, and
assign, after assigning the initial charging current to each charging bay of the plurality of charging bays that is coupled to a battery pack that requires a charging current, an additional charging current to one or more charging bays of the plurality of charging bays until the available charging current has been assigned,
wherein the plurality of buck converters provide the assigned charging currents to the plurality of charging bays.

17. The battery pack charger system of claim 16, wherein the controller is configured to assign a maximum charging current to a first charging bay and to assign the maximum charging current to one or more remaining charging bays until the available charging current has been assigned.

18. The battery pack charger system of claim 16, wherein the controller is configured to determine a requested charging current for a first charging bay and to assign the requested charging current to the first charging bay.

19. The battery pack charger system of claim 18, wherein determining the requested charging current is based on at least one of: a user input, a communication between a battery pack and the controller, or a detection of a parameter of the battery pack.

20. The battery pack charger system of claim 16, wherein the controller is configured to determine a remaining charging current after assigning the initial charging current to each charging bay of the plurality of charging bays that is coupled to a battery pack that requires a charging current, assign at least some of the remaining charging current to a first charging bay, determine an updated remaining current, and assign the updated remaining current to one or more remaining charging bays.
